(19) United States
(12) Patent Application Publication
(10) Pub. No.: US 2023/0060240 A1
(43) Pub. Date: Mar. 2, 2023

(54) MANUFACTURING METHOD OF ELECTROLYTIC CAPACITOR, ELECTROLYTIC CAPACITOR, AND MANUFACTURING APPARATUS OF ELECTROLYTIC CAPACITOR

(71) Applicant: KABUSHIKI KAISHA TOSHIBA, Tokyo (JP)

(72) Inventors: Kenichi OOSHIRO, Yokohama (JP); Kenya UCHIDA, Yokohama (JP); Kazuki MATSUMOTO, Kawasaki (JP); Masakuni IKAGAWA, Masakuni (JP)

(73) Assignee: KABUSHIKI KAISHA TOSHIBA, Tokyo (JP)

(21) Appl. No.: 17/654,272

(22) Filed: Mar. 10, 2022

(30) Foreign Application Priority Data
Aug. 31, 2021 (JP) 2021-141347

(51) Int. Cl. H01G 9/02; B05C 5/02; H01G 9/00

(52) U.S. Cl. CPC H01G 9/02; B05C 5/0204; H01G 9/0029

(57) ABSTRACT

According to a manufacturing method of an electrolytic capacitor according to an embodiment, a fiber film, which serves as a separator, is formed on a surface of a substrate, which serves as an electrode, by ejecting a material liquid against the substrate. When the fiber film is formed, thicker fiber is formed at end parts of the substrate in a width direction, compared to a center part of the substrate in the width direction.

### CROSS-REFERENCE TO RELATED APPLICATIONS

This application is based upon and claims the benefit of priority from Japanese Patent Application No. 2021-141347, filed Aug. 31, 2021, the entire contents of which are incorporated herein by reference.

### FIELD

An embodiment relates to a manufacturing method of an electrolytic capacitor, an electrolytic capacitor, and a manufacturing apparatus of an electrolytic capacitor.

### BACKGROUND

An electrolytic capacitor is widely used as a capacitor. In an electrolytic capacitor, a capacitor element is stored in the inside of a case. A capacitor element is constituted of a winding formed by winding a lamination of an anode and a cathode with a separator being interposed therebetween. In the inside of the case, the capacitor element is immersed in an electrolyte solution. An electrolytic capacitor in which either one of the electrodes (an anode and a cathode) constituting a pair is integrated with a separator is known. In the manufacturing of such an electrolytic capacitor, a fiber film is formed as a separator on the surface of a substrate, which is either one of the paired electrodes, by ejecting a material liquid against the electrode with a spinning method, etc.

In the manufacturing of an electrolytic capacitor, in order to immerse the separator in a conductive high polymer, the winding slated to be a capacitor element is, for example, immersed in a solution in which the conductive high polymer is dissolved before being immersed in an electrolyte solution. The conductive high polymer can thereby be retained in the separator of the electrolytic capacitor. As described above, in the electrolytic capacitor in which a separator is made of a fiber film integrated with either one of the electrodes, it is desired to effectively prevent an uneven distribution of a conductive high polymer in the fiber film. In other words, improved uniformity in the distribution of a conductive high polymer in a fiber film is desired.

### BRIEF DESCRIPTION OF THE DRAWINGS

FIG. 1 is a schematic diagram showing an example of an electrolytic capacitor according to a first embodiment.

FIG. 2 is a schematic view showing the electrolytic capacitor of FIG. 1 in a state in which a capacitor element is separated from a case.

FIG. 3 is a schematic view showing an example of a band-shaped body in which an anode and a separator are integrated in an electrolytic capacitor according to the first embodiment.

FIG. 4 is a schematic drawing showing a manufacturing apparatus for manufacturing a band-shaped body in the first embodiment.

FIG. 5 is a schematic drawing showing the electrospinning unit of the manufacturing apparatus of FIG. 4 in the state of forming an organic fiber film on the surface of a substrate, viewing the substrate (band-shaped body) in a cross section perpendicular or substantially perpendicular to a longitudinal direction.

FIG. 6 is a cross-sectional view of the electrolytic capacitor according to the first embodiment, schematically showing the center part of the band-shaped body in a width direction of the band-shaped body.

FIG. 7 is a cross-sectional view of the electrolytic capacitor according to the first embodiment, schematically showing the end part of the band-shaped body in a width direction of the band-shaped body.

FIG. 8 is a schematic view of an example of a process of immersing a capacitor element in a solution in which a conductive high polymer is dissolved in the manufacture of the electrolytic capacitor according to the first embodiment.

FIG. 9 is a schematic view showing an irregularities forming unit provided in a manufacturing apparatus for manufacturing a band-shaped body.

### DETAILED DESCRIPTION

According to a manufacturing method of an electrolytic capacitor according to an embodiment, a fiber film, which serves as a separator, is formed on the surface of a substrate, which serves as an electrode, by ejecting a material liquid against the substrate. When a fiber film is formed, thicker fiber is formed at the end parts of a substrate in the width direction, compared to the center part of the substrate in the width direction.

Hereinafter, the embodiments will be described with reference to the accompanying drawings.

### First Embodiment

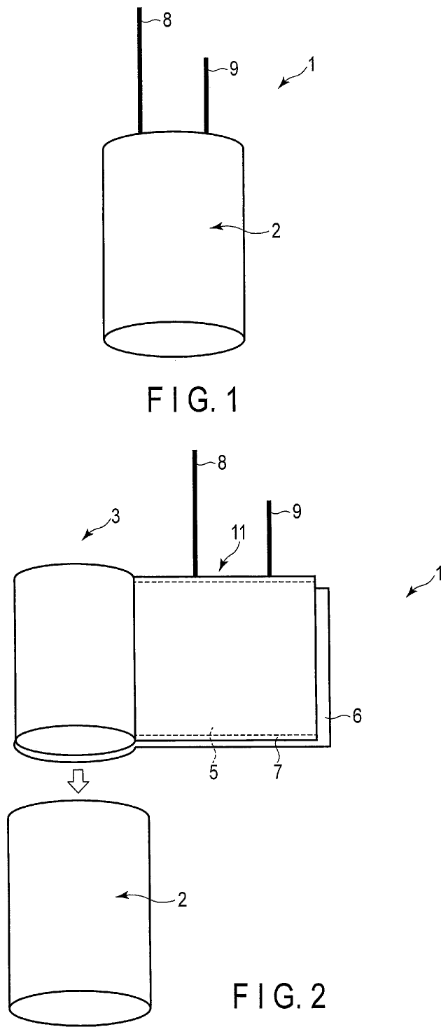

FIGS. 1 and 2 show an example of an electrolytic capacitor 1 according to the first embodiment. As shown in FIGS. 1 and 2, the electrolytic capacitor 1 includes a case 2 and a capacitor element 3 stored in the inside of the case 2. The case 2 is made of aluminum or an aluminum alloy, for example. In the inside of the case 2, the capacitor element 3 is immersed in an electrolyte solution. FIG. 2 shows the capacitor element 3 in a state of being separated from the case 2.

The capacitor element 3 includes an anode 5, a cathode 6, and a separator 7. In the capacitor element 3, the anode 5 and the cathode 6 are laminated, with the separator 7 being interposed therebetween. Then, a winding of a lamination of the anode 5, the cathode 6, and the separator 7 is formed into the capacitor element 3. The separator 7 has electric insulating properties, and the anode 5 and the cathode 6 are thereby electrically insulated in the capacitor element 3.

The anode 5 includes a metal layer having conductivity and a dielectric layer formed on the surface of the metal layer. In one example, the metal layer is made of aluminum or an aluminum alloy in the anode 5, and the dielectric layer is made of an aluminum oxide film. The cathode 6 includes a metal layer having conductivity. In one example, the metal layer of the cathode 6 is made of aluminum or an aluminum alloy. A lead terminal 8 on the anode side is connected to the metal layer of the anode 5. A lead terminal 9 of the cathode side is connected to the metal layer of the cathode 6. Each of the lead terminals 8 and 9 is made of a metal, etc. having conductivity and extends to the outside of the case 2.

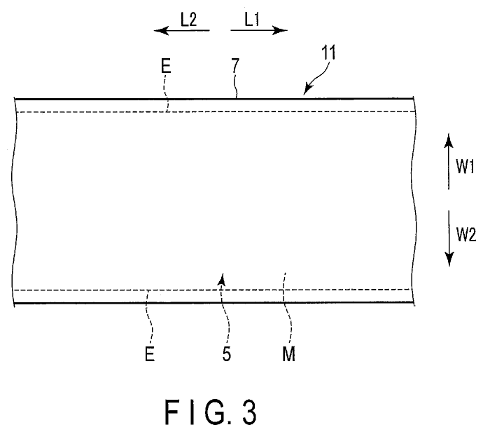

In the example shown in FIG. 2, etc., the separator 7 is integrated with the anode 5, and an organic fiber film formed on the surface of the anode 5 serves as the separator 7. FIG. 3 shows an example of a band-shaped body 11 in which the anode 5 and the separator 7 are integrated. As shown in FIG. 3, the band-shaped body 11, namely the substrate slated to be an anode 5 and the fiber film slated to be a separator 7, are defined by a longitudinal direction (a direction indicated by arrow L1 and arrow L2), a width direction intersecting (perpendicular to or substantially perpendicular to) the longitudinal direction (a direction indicated by arrow W1 and arrow W2), and a thickness direction intersecting both of the longitudinal direction and the width direction (a direction perpendicular to or substantially perpendicular to the sheet of FIG. 3). The anode 5 has a pair of main surfaces M. The paired main surfaces M face opposite to each other according to the thickness direction. In the anode 5, both main surfaces M are covered by the separator 7.

At each of both ends of the anode 5 in the width direction, an edge E is formed. In the anode 5, both edges E in the width direction are also covered by a fiber film, which serves as the separator 7. In the band-shaped body 11, the separator 7 sticks out of each edge E of the anode 5 toward the outside in the width direction. In the example shown in FIGS. 1 to 3, etc., a capacitor element 3 is formed by winding a lamination in which the cathode 6 is laminated on the band-shaped body 11. In the capacitor element 3, the longitudinal axis of the band-shaped body 11 corresponds to, or approximately corresponds to, a circumferential direction of the winding slated to be the capacitor element 3. Furthermore, in the capacitor element 3, the width direction of the band-shaped body 11 corresponds to, or approximately corresponds to, the direction along the center axis of the winding.

In one example, the separator 7 is integrated with the cathode 6, and an organic fiber film formed on the surface of the cathode 6 is slated to be the separator 7. In this case, similarly to the band-shaped body 11 in which the anode 5 and the separator 7 are integrated, a band-shaped body in which the fiber film slated to be a separator 7 and the cathode 6 are integrated is formed. Then, the anode 5 is laminated on the band-shaped body in which the cathode 6 and the separator 7 are integrated and a lamination of the band-shaped body and the anode 5 is wound to form a capacitor element 3.

As described above, in the present embodiment, a fiber film slated to be a separator 7 is integrated with a substrate slated to be one of the paired electrodes (the anode 5 and the cathode 6). A plate member slated to be an electrode having an opposite polarity to that of the substrate (namely, the other one of the anode 5 or the cathode 6) is laminated on a band-shaped body 11, and a lamination of the band-shaped body 11 and the plate member is wound to form a winding, which is slated to be the capacitor element 3.

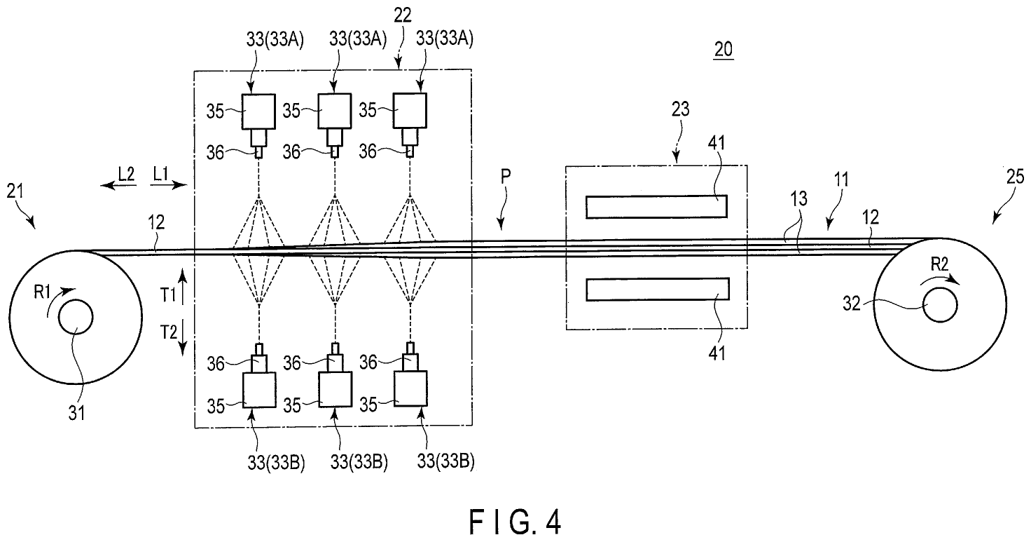

Herein, manufacturing of the electrolytic capacitor 1 is described. In the manufacturing of the electrolytic capacitor 1, a band-shaped body 11 in which a substrate slated to be one of the paired electrodes and a fiber film slated to be the separator are integrated is formed. FIG. 4 shows a manufacturing apparatus 20 for manufacturing a band-shaped body 11. The manufacturing apparatus 20 constitutes a part of the manufacturing apparatus for manufacturing the electrolytic capacitor 1. As shown in FIG. 4, the manufacturing apparatus 20 of the band-shaped body 11 has a delivery unit 21, a spinning unit 22, a surface processing unit 23, a winding unit 25, and a transfer path P. The transfer path P extends from the delivery unit 21 to the winding unit 25 via the spinning unit 22 and the surface processing unit 23. In the manufacturing apparatus 20, the substrate 12 slated to be either one of the paired electrodes is transferred from the delivery unit 21 to the winding unit 25, via the transfer path P.

In the transfer path P, the direction of transferring the substrate 12 (the band-shaped body 11), namely the direction toward the winding unit 25, is a downstream side. The direction opposite to the transfer direction, namely the direction toward the delivery unit 21, is an upstream side of the transfer path P. In the transfer path P, the first direction, which is a width direction intersecting (perpendicular or substantially perpendicular to) the transfer direction, and the second direction intersecting (perpendicular or substantially perpendicular to) both the transfer direction and the first direction are defined. In FIG. 4, the first direction (width direction) of the transfer path P is perpendicular to, or substantially perpendicular to, the sheet of the drawing.

The delivery unit 21 includes a reel 31. The substrate 12 is wound around the reel 31 in a roll. In the delivery unit 21, a driver member such as a driving motor (not shown) is driven to rotate the reel 31 in the direction of arrow R1. Thus, the substrate 12 wound around the reel 31 is fed out to the transfer path P. The winding unit 25 includes a reel 32. In the winding unit 25, a driver member such as a driving motor (not shown) is driven to rotate the reel 32 in the direction of arrow R2. Thus, the substrate 12 transferred via the transfer path P is wound into a roll by a reel 32.

In the manufacturing apparatus 20, when the reel 31 is rotated in the direction of arrow R1, which simultaneously rotates the reel 32 in the direction of arrow R2, the substrate 12 is transferred from the delivery unit 21 to the winding unit 25 via the transfer path P. In the transfer path P, the substrate 12 is transferred in the state where the width direction of the substrate 12 (the band-shaped body 11) corresponds to or substantially corresponds to the first direction (width direction) of the transfer path P and the thickness direction of the substrate 12 (the band-shaped body 11) corresponds to or substantially corresponds to the second direction of the transfer path P. In FIG. 4, the width direction of each of the substrate 12 and the band-shaped body 11 is perpendicular to, or substantially perpendicular to, the sheet of FIG. 4. In FIG. 4, the direction indicated by arrow L1 and arrow L2 is a longitudinal direction of the substrate 12 (the band-shaped body 11), and the direction indicated by arrow T1 and arrow T2 is a thickness direction of the substrate 12 (the band-shaped body 11).

The transfer path P may be provided with one or more guiding rollers (not shown) for guiding the substrate 12 from the delivery unit 21 to the winding unit 25. In this case, in the transfer path P, one or more guiding rollers are arranged at least between the delivery unit 21 and the spinning unit 22, between the spinning unit 22 and the surface processing unit 23, or between the surface processing unit 23 and the winding unit 25. The guiding roller may be arranged inside the spinning unit 22 or inside the surface processing unit 23.

The extension state of the transfer path P from the delivery unit 21 to the winding unit 25 is not particularly limited. The transfer path P extends along the horizontal direction in one example, and the transfer path extends along vertical direction in another example. One or more crimped or folded parts of the transfer path P are provided between the delivery unit 21 and the winding unit 25, and in these crimped or folded parts, the extending direction of the transfer path P may be changed. A folded part of the transfer path P is provided between the spinning unit 22 and the surface processing unit 23 in one example, and is provided in either the spinning unit 22 or the surface processing unit 23 in another example.

The spinning unit 22 forms a fiber film 13 made of organic fiber slated to be a separator in the width direction of the substrate 12 on the surface of the substrate 12, which is transferred on the transfer path P in the transfer direction. The band-shaped body 11 in which the substrate 12 and the fiber film 13 are integrated is thereby formed. The spinning unit 22 includes one or more spinning heads 33, and in the example of FIG. 4, six spinning heads 33 are provided in the spinning unit 22. Each of the spinning heads 33 includes a head main body 35 and a plurality of nozzles 36 projecting from the head main body 35. Each spinning head 33 is capable of keeping, in the head main body 35, a material liquid in which an organic substance is dissolved in a solvent. In each spinning head 33, the material liquid kept in the inside of the head main body 35 is ejected from each nozzle 36 against the substrate 12. The substrate 12 is conveyed through the side against which a material liquid is ejected, with respect to each spinning head 33.

In the spinning unit 22, a power supply source (not shown) is provided. In one example, the power supply source is a DC power supply source. In the spinning unit 22, the power supply source applies a voltage to the spinning head 33 so as to generate an electric potential difference between the substrate 12 transferred on the transfer path P and the nozzle 36. Then, the material liquid electrified by the application of the voltage to the nozzle 36 is ejected from the nozzle 36 against the substrate 12 and a fiber film 13 made of organic fiber is formed on the surface of the substrate 12. In the present embodiment, the material liquid from the nozzle 36 is ejected across the width direction of the substrate 12 transferred in the transfer direction, and the organic fiber film 13 is formed on the surface of the substrate 12 over the width direction of the substrate 12. The material liquid may be electrified in a positive polarity or a negative polarity. In the present embodiment, the material liquid from the nozzle 36 is ejected across the width direction of the substrate 12 transferred in the transfer direction and the fiber film 13 is thereby formed across the width direction of the substrate 12; however, in a case where, for example, at least one of the ends of the width direction of the substrate 12 is slated to be an electrode, an area against which the material liquid is not ejected from the nozzle 36 and a fiber film 13 is in turn not formed therein may be provided on at least one of the edge parts of the width direction of the substrate 12.

The material liquid is prepared by dissolving an organic substance in a solvent. As an organic substance used in a material liquid, one or more is selected from, for example, polyolefin, polyether, polyimide, polyketon, polysulfon, cellulose, polyvinyl alcohol, polyamide, polyamideimide, a polyvinylidene fluoride. Polyolefin is for example polypropylene or polyethylene.

The voltage between each nozzle 36 of the spinning head 33 and the substrate 12 is set as appropriate according to types of a solvent and a dissolved substance in a material liquid, a boiling point and a vapor pressure curve of a solvent of a material liquid, a concentration and a temperature of a material liquid, a shape of the nozzle 36, and a distance between the substrate 12 and the nozzle 36, and the like. In one example, a voltage (electric potential difference) applied between each nozzle 36 of the spinning head 33 and the substrate 12 is set between 1 kV and 100 kV as appropriate. The ejection speed of the material liquid from each nozzle 36 of the spinning head 33 corresponds to a concentration, a viscosity, and a temperature of the material liquid, a voltage applied between each nozzle 36 of the spinning head 33 and the substrate 12, a shape of the nozzle 36, and the like.

As explained above, the spinning unit 22 according to the present embodiment forms a fiber film 13 made of organic fiber on the surface of the substrate 12 with an electrospinning method (sometimes called “electric charge induction spinning method”). A band-shaped body 11 in which a substrate 12 slated to be an electrode (either one of the anode 5 or the cathode 6) and a fiber film 13 slated to be a separator 7 are integrated is thus formed. In one example, a voltage may be applied to any of a supply source of a material liquid to the spinning head 33 or a supply path of a material liquid provided between the supply source and the spinning head 33 by the above-described power supply source, and the material liquid may be thereby electrified. Also in this case, the electrified material liquid is ejected against the substrate 12 from each nozzle 36.

In the spinning unit 22, the formation of the organic fiber film 13 on the surface of the substrate 12 may be achieved with a method other than an electrospinning method. In one example, an organic fiber film 13 is formed on the surface of the substrate 12 with a solution blow spinning method, instead of an electrospinning method. Also in this case, in the spinning unit 22, a material liquid in which an organic substance is dissolved in a solvent is ejected against the surface of the substrate 12 from each nozzle 36 of the spinning head 33.

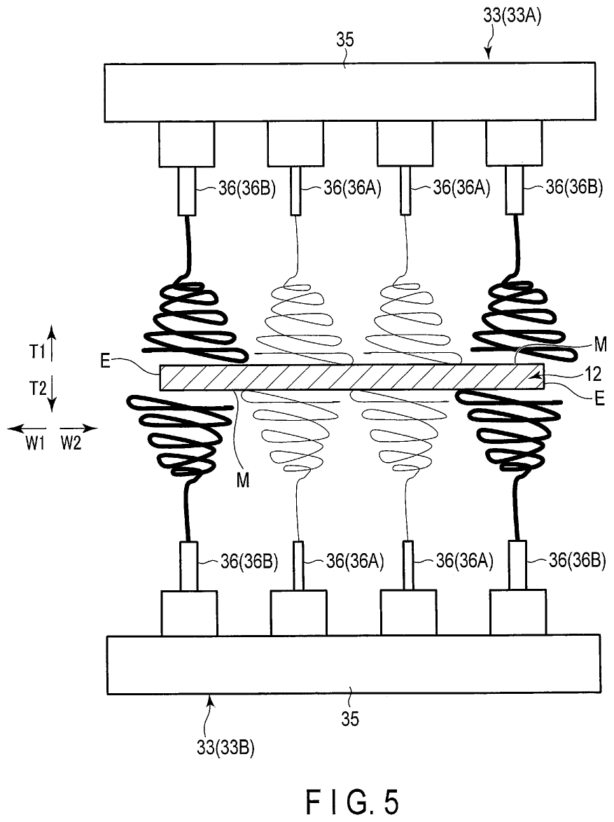

FIG. 5 shows the spinning unit 22 in the state of forming an organic fiber film 13 on the surface of the substrate 12, viewing the substrate 12 (the band-shaped body 11) in a cross section perpendicular to, or substantially perpendicular to, the longitudinal direction. FIG. 5 shows the spinning head 33 viewed from the upstream side or the downstream side of the transfer path P. In the example shown in FIGS. 4 and 5, six spinning heads 33 consist of three spinning heads 33A and three spinning heads 33B which differ from the spinning head 33A. Each spinning head 33A ejects a material liquid against the substrate 12 from one side of the second direction of the transfer path P, and each spinning head 33B ejects a material liquid against the substrate 12 from the opposite side of the second direction, which is the opposite side of the ejection side of the spinning head 33A. Since the material liquid is ejected against the substrate 12 from both sides of the second direction, both of the main surfaces M of the substrate 12 (either one of the anode 5 or the cathode 6) are covered by the fiber film 13 slated to be the separator 7.

In the example shown in FIGS. 4 and 5, each spinning head 33 includes four nozzles 36, and a row of these nozzles 36 aligned in the first direction of the transfer path P is formed. In other words, in each row of nozzles in the spinning head 33, a plurality of nozzles 36 are aligned in the width direction (the direction indicated by arrow W1 and arrow W2) of the substrate 12 (the band-shaped body 11). In FIG. 5, the direction indicated by arrow W1 and arrow W2 is a width direction of the substrate 12 (the band-shaped body 11), and the direction indicated by arrow T1 and arrow T2 is a thickness direction of the substrate 12 (the band-shaped body 11).

In each spinning head 33, the plurality of nozzles 36 consist of two kinds of nozzles, nozzles 36A and nozzles 36B. In the example shown in FIGS. 4 and 5, each spinning head 33 includes two nozzles (first nozzles) 36A and two nozzles (second nozzles) 36B. In each spinning head 33, the nozzles 36B are arranged at the ends of the nozzle row in the second direction of the transfer path P (the width direction of the substrate 12). In each nozzle row of the spinning head 33, in turn, the nozzles 36A are interposed between the nozzles 36B according to the second direction of the transfer path P. Accordingly, in each spinning head 33, the nozzles 36A are arranged at the center part of the nozzle row in the second direction of the transfer path P (the width direction of the substrate 12).

In each of the spinning heads 33, the nozzles (first nozzles) 36A eject a material liquid against the center part of the substrate 12 in the width direction of the substrate 12 (the first direction of the transfer path P). For this reason, the center part of each of the main surfaces M in the width direction of the substrate 12 is covered by the fiber film 13 formed from the material liquid ejected by the nozzles 36A. In each of the spinning heads 33, the nozzles (second nozzles) 36B eject a material liquid against the edge parts of the substrate 12 according to the width direction of the substrate 12 (the first direction of the transfer path P). For this reason, the edges E of the substrate 12 and the vicinity thereof in the width direction of the substrate 12 are covered by the fiber film 13 formed from the material liquid ejected by the nozzles 36B. Thus, the parts projecting from the edges E of the substrate 12 outwardly in the width direction in the fiber film 13 are formed from the material liquid ejected from the nozzles 36B.

In each spinning head 33, the nozzles (second nozzles) 36B form fiber in the fiber film 13 thicker than the fiber formed by the nozzles (first nozzles) 36A. For this reason, in the fiber film 13, a fiber diameter in the part made of the material liquid ejected from the nozzles 36B is larger than that in the part made of the material liquid ejected from the nozzles 36A. In one example, each nozzle 36B is formed in such a manner that the bore diameter of the ejection port of the nozzle 36B is larger than that of the nozzle 36A. It is thereby possible for the nozzles 36B to form thicker fibers than the fibers formed by the nozzles 36A. In another example, the material liquid ejected from each nozzle 36B has a higher concentration of the organic substance dissolved in a solvent than the material liquid from each nozzle 36A. It is thereby possible for the nozzles 36B to form thicker fibers than the fibers formed by the nozzles 36A.

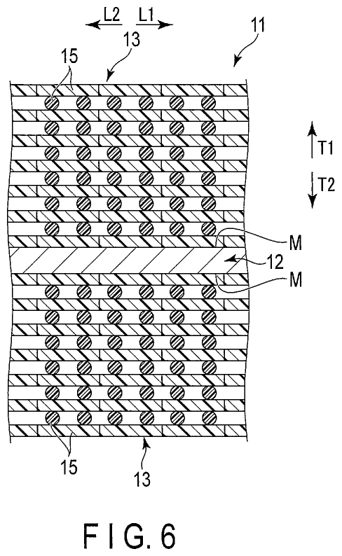

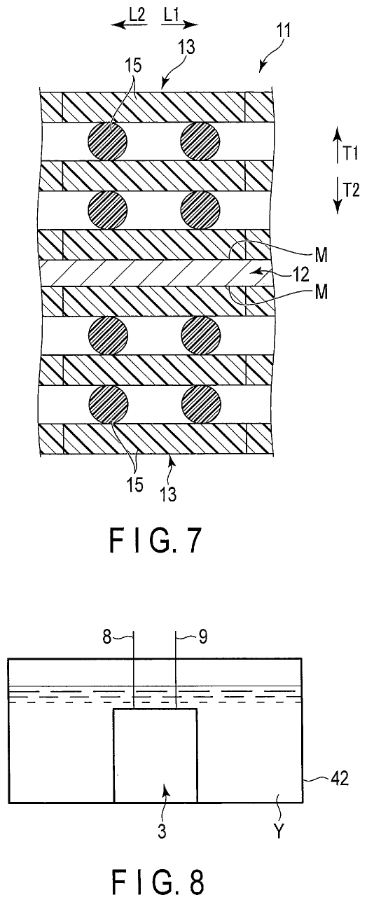

FIG. 6 shows the center part of the band-shaped body 11 in the width direction of the band-shaped body 11, and FIG. 7 shows the end parts of the band-shaped body 11 in the width direction of the band-shaped body 11. Each of FIGS. 6 and 7 shows a cross section perpendicular or substantially perpendicular to the width direction of the band-shaped body 11. In the present embodiment, two kinds of nozzles 36A and 36B are used to form the fiber film 13 on the surface of the substrate 12 as described above. For this reason, the fiber 15 of the fiber film 13 is thicker in the end parts of the substrate 12 in the width direction of the band-shaped body 11 than in the center part of the substrate 12 in the width direction of the band-shaped body 11. Therefore, the diameter of the fiber 15 in the fiber film 13 is larger in both edges E and the vicinity thereof of the substrate 12 according to the width direction of the band-shaped body 11 than in the center part of the substrate 12 according to the width direction of the band-shaped body 11.

Furthermore, as the fiber film 13 is formed in the above-described manner, an open area ratio (porosity) in the fiber film 13 is larger in the end parts of the band-shaped body 11 in the width direction than in the center part of the band-shaped body 11 in the width direction. Herein, in the fiber film 13, the ratio of an area through which a fluid can pass per predetermined unit area is defined as an open area ratio. In other words, the porosity per predetermined size of an area is an open area ratio.

As shown in FIG. 4, when a fiber film 13 is formed on the surface of the substrate 12 in the spinning unit 22 in the above-described manner, the band-shaped body 11 in which the substrate 12 and the fiber film 13 are integrated is transferred to the surface processing unit 23. Then, surface processing is performed on the surface of the fiber film 13 by the surface processing unit 23 to improve wettability. In the example of FIG. 4, the surface processing unit 23 includes a radiator 41, and the radiator 41 emits ultraviolet radiation against the fiber film 13. Thus, oil components, etc. adhered on the surface of the fiber film 13 are thereby removed and the wettability of the surface of the fiber film 13 is thus improved.

Accordingly, wettability of the surface of the fiber film 13 improves after surface processing is performed by the surface processing unit 23. Improved wettability of the surface of the fiber film 13 makes it easier for a liquid to adhere to the surface of the fiber film 13. Furthermore, after the surface processing, a contact angle of a liquid (droplet) with respect to the surface of the fiber film 13 becomes smaller. Thus, the quality of the surface of the fiber film 13 is modified by the surface processing in such a manner that a liquid can easily adhere to the surface.

In one example, surface processing for improving wettability is performed through injection of an ozone gas onto the surface on the fiber film 13. In another example, surface processing for improving wettability is performed through injection of plasma onto the surface on the fiber film 13. In either case, similarly to the case where the surface of the fiber film 13 is irradiated with ultraviolet radiation, oil components, etc. adhered on the surface of the fiber film 13 can be removed and the wettability of the surface of the fiber film 13 can be improved. The band-shaped body 11 with the surface of the fiber film 13 being treated by the surface processing as described above is wound around the reel 32 of the winding unit 25 in a roll.

In the manufacturing of the electrolytic capacitor 1, after a band-shaped body 11 is formed by the manufacturing apparatus 20 as described above, a capacitor element 3 is formed using the band-shaped body 11. In the formation of the capacitor element 3, a plate member slated to be an electrode having the polarity opposite to the polarity of the substrate 12 is laminated on the band-shaped body 11 in which the substrate 12 slated to be an electrode (either the anode 5 or the cathode 6) and the fiber film 13 slated to be the separator 7 are integrated. In other words, the plate member slated to be an electrode having the polarity opposite to that of the substrate 12 is laminated on the substrate 12, with the fiber film 13 being interposed therebetween. At this time, with the fiber film 13 electrically insulating between the substrate 12 and the plate member, the substrate 12, the fiber film 13, and the plate member are laminated. Then, a winding slated to be a capacitor element 3 is formed by winding the lamination of the substrate 12, the fiber film 13, and the plate member. As described above, the capacitor element 3 is constituted by a lamination of a substrate 12, a fiber film 13, and a plate member.

Then, the capacitor element 3 formed in this manner is immersed in a solution in which a conductive high polymer is dissolved. FIG. 8 shows an example of a process of immersing the capacitor element 3 in a solution in which a conductive polymer is dissolved in the manufacture of the electrolytic capacitor 1. In the example of FIG. 8, the processing tank 42 is filled with a solution Y in which the conductive high polymer is dissolved. Then, the capacitor element (winding) 3 is immersed in the solution Y that fills the inside of the processing tank 42. The capacitor element 3 is arranged inside the processing tank 42 in such a manner that the entire parts of the capacitor element except for the lead terminals 8 and 9 are immersed in the solution Y. Herein, the conductive high polymer to be dissolved maybe polyacetylene or polythiophene, for example.

By immersing the capacitor element 3 in the solution Y as described above, the fiber film 13 slated to be the separator 7 is impregnated with the conductive high polymer. After being immersed in the solution Y for a certain length of time, the capacitor element 3 is removed from the solution Y. With the capacitor element 3 immersed in the solution Y, the fiber film 13 is impregnated with the conductive high polymer; for this reason, the capacitor element 3 removed from the solution Y is able to retain the conductive high polymer in the separator 7 (the fiber film 13).

In the manufacture of the electrolytic capacitor 1, the capacitor element 3 in which the fiber film 13 is impregnated with the conductive high polymer is stored in the case 2. At this time, the capacitor element 3 is arranged in the case 2 in such a manner that the lead terminals 8 and 9 extend outside of the case 2. Then, an electrolyte solution is injected into the inside of the case 2, and the capacitor element 3 is impregnated with the electrolyte solution. Subsequently, the case 2 is hermetically sealed and the electrolytic capacitor 1 is thereby formed.

In the present embodiment, when a fiber film 13 is formed on the substrate 12, the fibers are formed thicker in the end parts of the substrate 12 in the width direction than in the center part of the substrate 12 in the width direction. For this reason, the open area ratio of the fiber film 13 is higher in the end parts (edge parts) of the band-shaped body 11 in the width direction than in the center part of the band-shaped unit 11 in the width direction, and this allows easy passing of a fluid.

Herein, with the winding, which is a capacitor element 3, being immersed in a solution Y in which a conductive high polymer is dissolved, the conductive high polymer invades the fiber film 13 from the ends (edges) of the band-shaped body 11 in the width direction. In the present embodiment, the open area ratio of the fiber film 13 is high in the end parts of the band-shaped body 11 according to the width direction; for this reason, in the fiber film 13, it is easier for the conductive high polymer that has invaded the ends of the band-shaped body 11 in the width direction to reach the center part of the band-shaped body 11 in the width direction. By making it easier for the conductive high polymer to reach the center part of the band-shaped body 11 in the width direction, effective prevention of uneven distribution of the conductive high polymer in the fiber film 13 slated to be the separator 7 in the electrolytic capacitor 1 formed in the above-described manner can be achieved. In other words, the uniformity in the distribution of the conductive high polymer in the fiber film 13 is improved in the electrolytic capacitor 1.

In the present embodiment, surface processing is performed on the surface of the fiber film 13 in order to improve wettability, with the fiber film 13 being formed on the surface on the substrate 12. By the surface processing, wettability of the surface of the fiber film 13 is improved compared to the wettability before the surface processing is performed. Through the improved wettability on the surface of the fiber film 13, it is easier for a liquid to adhere to the surface of the fiber film 13 with the capacitor element 3 immersed in a solution Y in which a conductive high polymer is dissolved. Easier adherence of a liquid on the surface of the fiber film 13, in turn, makes it easy to impregnate the fiber film 13 with the conductive high polymer. Easier impregnation of the fiber film 13 with the conductive high polymer leads to retaining of an appropriate amount of the conductive high polymer in the fiber film 13 in the electrolytic capacitor 1 formed in the above-described manner.

As described above, in the electrolytic capacitor 1 of the present embodiment, the uniformity in the distribution of the conductive high polymer in the fiber film 13 can be improved and an appropriate amount of a conductive high polymer can be retained in the fiber film 13. The performance of the electrolytic capacitor 1 is thereby improved. The easy accession of the conductive high polymer to the center part of the band-shaped body 11 in the width direction leads to an improvement in material efficiency, etc., in the manufacture of the electrolytic capacitor 1. It is thereby possible to save work and cost in the manufacture of the electrolytic capacitor 1.

In the substrate 12, burrs may be formed at the edges E and the vicinity thereof. In the present embodiment, the fiber of the fiber film 13 is therefore formed thick in the end parts of the band-shaped body 11 in the width direction as described in the above. For this reason, burrs, etc. formed in the substrate 12 are appropriately covered by the fiber film 13 and the exposures of the burrs are effectively prevented in the band-shaped body 11. Through the effective prevention of burrs, etc. from being exposed, it is possible to effectively avoid contact of the substrate 12 with an electrode having a polarity opposite to that of the substrate 12. It is thereby possible to effectively prevent short circuits between the anode 5 and the cathode 6 in the electrolytic capacitor 1.

(Modifications)

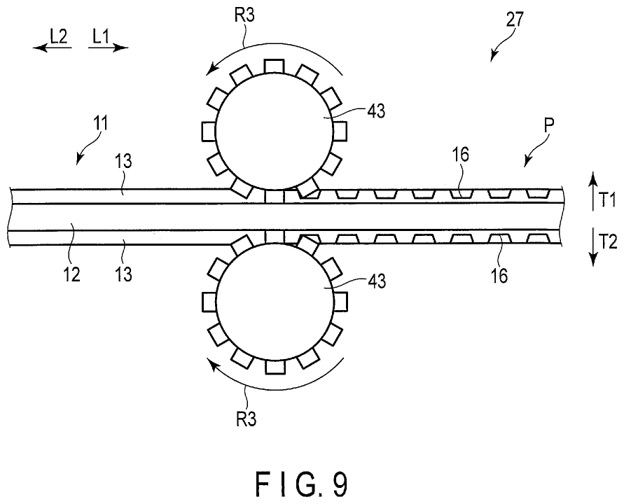

In one modification, as shown in FIG. 9, an irregularities forming unit 27 is provided in the manufacturing apparatus 20 that manufactures the band-shaped body 11. The irregularities forming unit 27 is located between the spinning unit 22 and the surface processing unit 23 in the transfer path P, for example. The irregularities forming unit 27 forms irregularities 16 on the surface of the fiber film 13, with the fiber film 13 being formed on the surface of the substrate 12.

In the example shown in FIG. 9, the irregularities forming unit 27 includes a pair of rollers 43. Each roller 43 has a central axis in the first direction of the transfer path P (the width direction of the band-shaped body 11) and is rotatable about the central axis. The outer periphery of each of the rollers 43 is formed with an irregular surface along the circumferential direction (the direction around the center axis), around the entire circumference in the circumferential direction. The rollers 43 constituting a pair are abutted to the band-shaped body 11 as opposed to each other in the second direction of the transfer path P (the thickness direction of the band-shaped body 11) and each of the rollers 43 is abutted to the surface of the fiber film 13.

In the irregularities forming unit 27, with the rollers 43 abutted to the band-shaped body 11 being transferred, each of the rollers 43 is rotated in the direction indicate by arrow R3. The irregularities 16 are thus formed on the surface of the fiber film 13. In FIG. 9, the left side corresponds to the upstream side of the transfer path P and the right side corresponds to the downstream side. In the example of FIG. 9, when the band-shaped body 11 passes the pair of rollers 43 from the upstream side to the downstream side, the irregularities 16 are formed on the surface of the fiber film 13.

Herein, the irregularities 16 are formed on the surface of the fiber film 13 along the longitudinal direction of the band-shaped body 11. On the surface of the fiber film 13, the irregularities 16 are formed only on the end parts of the band-shaped body 11 in the width direction of the band-shaped body 11. In other words, the irregularities 16 are not formed in the center part of the band-shaped body 11 in the width direction of the band-shaped body 11. FIG. 9 shows the band-shaped body 11, viewed from one side of the first direction of the transfer path P (the width direction of the band-shaped body 11).

After the irregularities are formed on the surface of the fiber film 13 by the irregularities forming unit 27, the surface processing unit 23 performs surface processing for improving wettability on the surface of the fiber film 13, similarly to the foregoing embodiment. Subsequently, the band-shaped body 11 in which the surface of the fiber film 13 is processed is wound around by the winding unit 25. In one example, after the fiber film 13 is formed by the spinning unit 22, surface processing is first performed on the surface of the fiber film 13 by the surface processing unit 23. After the surface processing, the irregularities forming unit 27 forms the irregularities 16 on the surface of the fiber film 13.

Operations and advantageous effects similar to those of the foregoing embodiment, etc. are achieved in the present modification. In the present modification, the irregularities 16 are formed on the surface of the fiber film 13 in each of the end parts (edge parts) of the band-shaped body 11 in the width direction. For this reason, the recess parts of the irregularities 16 create voids on the surface of the fiber film 13; as a result, the open area ratio of the fiber film 13 is further increased in each of both end parts in the width direction. For this reason, with the capacitor element 3 being immersed in a solution in which a conductive high polymer is dissolved, it is further easier for the high polymer that has invaded the end parts of the band-shaped body 11 in the width direction to reach the center part of the band-shaped body 11 in the width direction. Thus, the uniformity in the distribution of the conductive high polymer in the fiber film 13 is further improved in the electrolytic capacitor 1 formed in the above-described manner.

According to at least one of the foregoing embodiment and modification, a fiber film slated to be a separator is formed on the surface of a substrate slated to be the electrode by ejecting a material liquid against the substrate. Furthermore, when a fiber film is formed, thicker fiber is formed at the end parts of a substrate in the width direction, compared to the center part of the substrate in the width direction. It is thereby possible to provide a manufacturing method of an electrolytic capacitor with which a fiber film slated to be a separator in conjunction with either one of the electrodes is formed and uniformity of a conductive high polymer in the fiber film is improved, and an electrolytic capacitor manufactured with the manufacturing method, and a manufacturing apparatus of the electrolytic capacitor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A manufacturing method of an electrolytic capacitor, the manufacturing method comprising:
ejecting a material liquid against a substrate slated to be an electrode to form a fiber film slated to be a separator on a surface of the substrate; and
in the formation of the fiber film, forming fiber thicker in end parts of the substrate in the width direction than fiber formed in a center part of the substrate in the width direction.

2. The manufacturing method according to claim 1, further comprising performing surface processing for improving wettability on a surface of the fiber film with the fiber film being formed on the surface of the substrate.

3. The manufacturing method according to claim 1, further comprising forming irregularities on the surface of the fiber film with the fiber film being formed on the surface of the substrate.

4. The manufacturing method according to claim 1, further comprising:
laminating a plate member slated to be an electrode having a polarity opposite to that of the substrate on the substrate with the fiber film being interposed therebetween to form a capacitor element from a lamination of the substrate, the fiber film, and the plate member; and
immersing the capacitor element in a solution in which a conductive high polymer is dissolved to impregnate the fiber film with the conductive high polymer.

5. An electrolytic capacitor comprising:
a substrate slated to be an electrode;
a fiber film formed on a surface of the substrate and slated to be a separator, fiber of the fiber film being thicker in end parts of the substrate in a width direction than fiber in a center part of the substrate in the width direction.

6. A manufacturing apparatus of an electrolytic capacitor, the manufacturing apparatus comprising a spinning head,
the spinning head being configured to eject a material liquid against a substrate slated to be an electrode to form a fiber film slated to be a separator on a surface of the substrate, wherein
the spinning head including:
a first nozzle configured to eject the material liquid against a center part of the substrate in a width direction; and
a second nozzle configured to eject the material liquid against end parts of the substrate in the width direction and form thicker fiber than the fiber formed by the first nozzle.
